(19) United States
(12) Patent Application Publication
(10) Pub. No.: US 2015/0282227 A1
(43) Pub. Date: Oct. 1, 2015

(54) WEARABLE COMPUTING SYSTEM

(71) Applicants: Mohamed Yousef, Cairo (EG); Menna A. Ghoneim, Cairo (EG); Hani H. Elgebaly, Cairo (EG)

(72) Inventors: Mohamed Yousef, Cairo (EG); Menna A. Ghoneim, Cairo (EG); Hani H. Elgebaly, Cairo (EG)

(21) Appl. No.: 14/225,106

(22) Filed: Mar. 25, 2014

(51) Int. Cl. H04W 76/02; H04B 1/3827; H04W 8/00; G06F 1/16; G06F 9/54

(52) U.S. Cl. CPC H04W 76/023; G06F 1/163; G06F 9/54; H04W 8/005; H04B 1/385

(57) ABSTRACT

Technology for implementing one or more wearable usage scenario applications is disclosed. One or more types of input data may be received from a wearable wireless input node at a wearable wireless processing node. The one or more wearable usage scenario applications may be executed at the wearable wireless processing node using the input data received from the wearable wireless input node. One or more types of physical output may be provided from the wearable wireless processing node to a wearable wireless output node based on the one or more wearable usage scenario applications executed at the wearable wireless processing node using the one or more types of input data.

### BACKGROUND

The popularity of wearable technology, such as smart watches and smart eyewear, has grown in recent years. Wearable technology may include clothing or accessories that incorporate computer and electronic technologies. Wearable technology may perform a variety of functions that are beneficial to a user, in addition to being aesthetically pleasing to the user. Wearable technology may provide numerous types of features, such as music listening, global positioning system (GPS) capabilities, activity tracking, telephony services, Internet browsing, etc. for the user that is wearing the wearable technology.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 illustrates a wearable computing system including an input node, a processing node and an output node worn by a user in accordance with an example;

FIG. 2 is a block diagram of a wearable wireless input node in accordance with an example;

FIG. 3 is a block diagram of a wearable wireless output node accordance in with an example;

FIG. 4 is a block diagram of a wearable wireless processing node in accordance with an example;

FIG. 5 is a block diagram illustrating communications between a wearable wireless input node, a wearable wireless processing node, a wearable wireless output node and one or more service providers in accordance with an example;

FIG. 6 is a block diagram illustrating a wearable computing system in accordance with an example;

FIG. 7 depicts functionality of computer circuitry of a wearable computing system operable to implement one or more wearable usage scenario applications in accordance with an example;

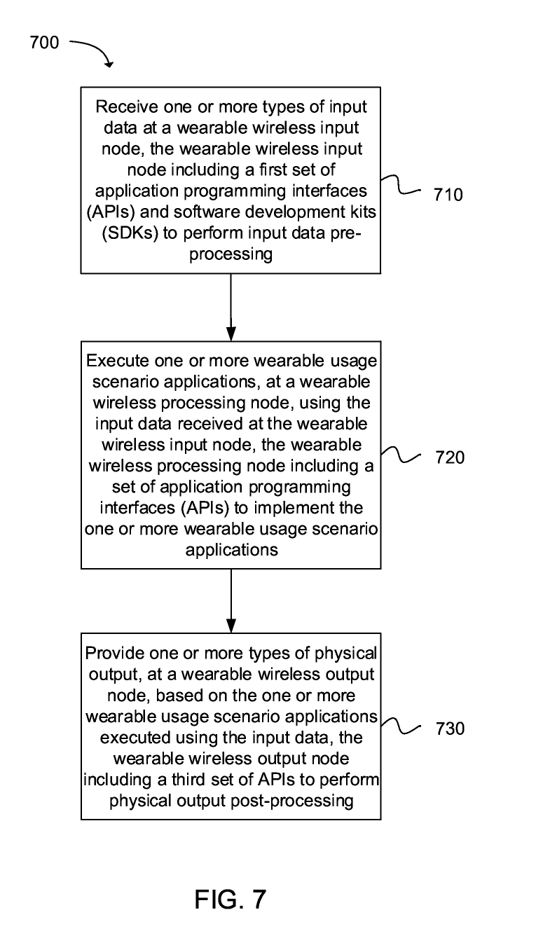

FIG. 8 depicts a flow chart of a method for implementing one or more wearable usage scenario applications in accordance with an example;

FIG. 9 illustrates a diagram of a wireless device (e.g., UE) in accordance with an example.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Wearable computing devices offer a variety of useful and convenient features for users over traditional mobile computing devices. Wearable computing devices include smart watches, smart glasses, health and fitness devices, etc. that enable users to access the Internet, check email, listen to music, monitor heart rate and physical activity, etc. Wearable computing devices also have the potential to improve worker efficiency in various industries, such as manufacturing, field services, retail and healthcare.

Traditional wearable computing devices are purpose-built devices that include an input function, a processing function and an output function in a single unmodifiable device. Each wearable computing device is treated as a standalone entity with input, output and processing functionalities integrated in one form factor. In other words, hardware and processing capabilities of prior wearable computing devices (e.g., memory, processing power, sensors, and electronic components) may not be modified after the wearable computing device is built.

Since wearable computing devices currently in the marketplace generally implement a single usage model, users may purchase multiple wearable computing devices to serve multiple usage scenarios. Although wearable computing devices may access and download new applications for additional features, the new applications are limited to the hardware capabilities of the wearable computing device. In other words, if the wearable computing device that was originally purchased does not include a heart rate monitoring sensor, then the user would have to purchase a new wearable computing device in order to obtain a heart rate monitoring functionality. The use of multiple wearable computing devices may have health implications due to radio frequency signal absorption rates in the body.

A wearable computing system is described that can enhance the functionality of traditional wearable computing devices. The wearable computing system may include multiple nodes. The multiple nodes may include wearable wireless nodes that are worn and operated by a user. The multiple nodes may include a wearable wireless input node, a wearable wireless processing node, and a wearable wireless output node. In some examples, the wearable wireless input node is in a first enclosure, a wearable wireless processing node is in a second enclosure, and a wearable wireless output node is in a third enclosure. The wearable computing system described offers a centralized processing entity, wearable wireless input nodes, wearable wireless output nodes, and a unified communication scheme that can support multiple usage models. As a result, redundant system components and the associated power consumption and radiation consequences as a result of the redundant system components may be eliminated. The elimination of redundant system components may result in the least number of health and radio emission implications for the user wearing the wearable computing system.

As described in further detail below, the wearable computing system may include a modular architecture consisting of a processing entity and a set of input and output wearable wireless nodes. The wearable computing system may assign roles and responsibilities to each of the wearable wireless nodes and facilitate coordination between the wearable wireless nodes when implementing extended usage models.

The wearable computing system may connect to other wearable networks that are located in proximity to the wearable computing system in order to implement multiple network coordination and enhanced functionality that is facilitated by the network topology and architecture. The communications between the wearable computing system and the other proximately-located wearable networks may be regulated using a number of communication standards.

Additional wearable wireless nodes (e.g., including various types of sensors) may be added or removed from the wearable computing system in a seamless manner. The additional of new wearable usage scenarios may be supported by adding application software and assigning the necessary standard hardware resources. As a result, the features and capabilities of the wearable computing system may be personalized according to the user wearing the wearable computing device.

Wireless mobile communication technology uses various standards and protocols to transmit data between the wearable wireless nodes. Some wearable wireless nodes may communicate using orthogonal frequency-division multiple access (OFDMA) in a downlink (DL) transmission and single carrier frequency division multiple access (SC-FDMA) in an uplink (UL) transmission. Standards and protocols that use orthogonal frequency-division multiplexing (OFDM) for signal transmission include the third generation partnership project (3GPP) long term evolution (LTE), (e.g. Releases 8, 9, 10 or 11), the Institute of Electrical and Electronics Engineers (IEEE) 802.16 standard (e.g., 802.16e or 802.16m), which is commonly known to industry groups as WiMAX (Worldwide interoperability for Microwave Access), and the IEEE 802.11 standard (e.g. 802.11-2012, 802.11ac, 802.11ad), which is commonly known to industry groups as WiFi.

Wearable wireless nodes may be capable of communicating via licensed spectrum, such as through a cellular network, and via unlicensed spectrum, such as via a WiFi hotspot. WiFi is a common name provided to the IEEE 802.11 set of standards for communicating in unlicensed spectrum including the 2.4, 3.7 and 5 GHz frequency bands. The set of standards includes the IEEE 802.11a standard released in 1999 for communication in the 5 GHz and 3.7 GHz band, the IEEE 802.11b standard, also released in 1999 for communication in the 2.4 GHz band, the 802.11g standard released in 2003 for communication in the 2.4 GHz range via orthogonal frequency division multiplexing (OFDM) and/or direct sequence spread spectrum (DSSS), and the 802.11n standard released in 2009 for communication in the 2.4 GHz and 5 GHz bands using multiple-input multiple-output (MIMO).

While WiFi has been given as an example of a standard used to communicate via an unlicensed portion of the radio frequency spectrum, additional standards for communicating in a portion of the unlicensed spectrum may also be used, including the IEEE 802.15 family of personal area networks (PAN), such as 802.15-6 for body area networks (BAN). Other examples of communication standards for wearable wireless nodes may include Bluetooth, Bluetooth low energy, low power WiFi, or other wireless local area network standards.

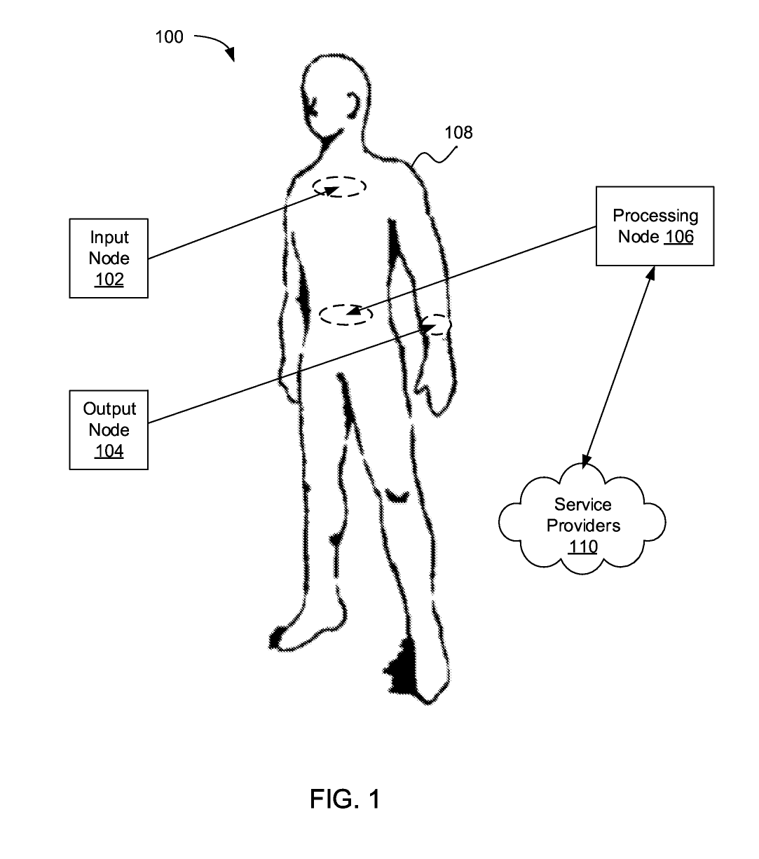

FIG. 1 illustrates an exemplary wearable computing system 100 worn by a user 108. The wearable computing system 100 may include an input node 102, an output node 104 and a processing node 106. In one example, the input node 102, output node 104 and processing node 106 may be wearable wireless nodes. In addition, the processing node 106 may communicate with service providers 110. In the example shown in FIG. 1, the input node 102 may be in a first enclosure, the output node 104 may be in a second enclosure, and the processing node 106 may be in a third enclosure. In an alternative configuration, the input node 102, output node 104 and processing node 106 may be within the same enclosure or in multiple enclosures. For example, the input node 102 and the output node 104 may be in a first enclosure and the processing node 106 may be in a second enclosure. Although the example in FIG. 1 illustrates the input node 102 being worn on the user's chest, the output node 104 being worn on the user's wrist, and the processing node 106 being worn on the user's waist, the input node 102, output node 104 and processing node 106 may be attached to a variety of areas on the user's body, such as the user's arm, chest, head, waist, leg, back, and calf.

The input node 102 may receive one or more types of input data. The input node 102 may include a camera, microphone, sensor, etc. to capture the input data. The input data may include, but is not limited to, body characteristics (e.g., heart rate), videos, images, sounds, temperature, etc. The output node 104 may provide one or more types of physical output. The output node 104 may include a display screen, speaker, actuator, etc. to provide the physical output.

The processing node 106 may execute one or more wearable usage scenario applications using the input data received at the input node 102. In general, the term “wearable usage scenario applications” generally refers to application software executed on the wearable computing system 100 in order to perform useful tasks for the user 108. The wearable usage scenario applications may provide various functionalities and types of information to the user 108, such as email, calendar, contacts, stock market information, and weather information. In one example, the processing node 106 may execute the wearable usage scenario application and provide the physical output to the user 108 via the output node 104. In addition, the processing node 106 may execute the wearable usage scenario application using the input data captured at the input node 102.

In one configuration, the processing node 106 may communicate with service providers 110 on a cloud computing network. For example, the service providers 110 may be located on a cloud server. The service providers 110 may provide various types of information to the processing node 106 to enable the processing node 106 to execute the wearable usage scenario applications. Therefore, the processing node 106 may use information received from the service providers 110 and input data captured by the input node 102 when executing the wearable usage scenario applications and generating the physical output at the output node 104.

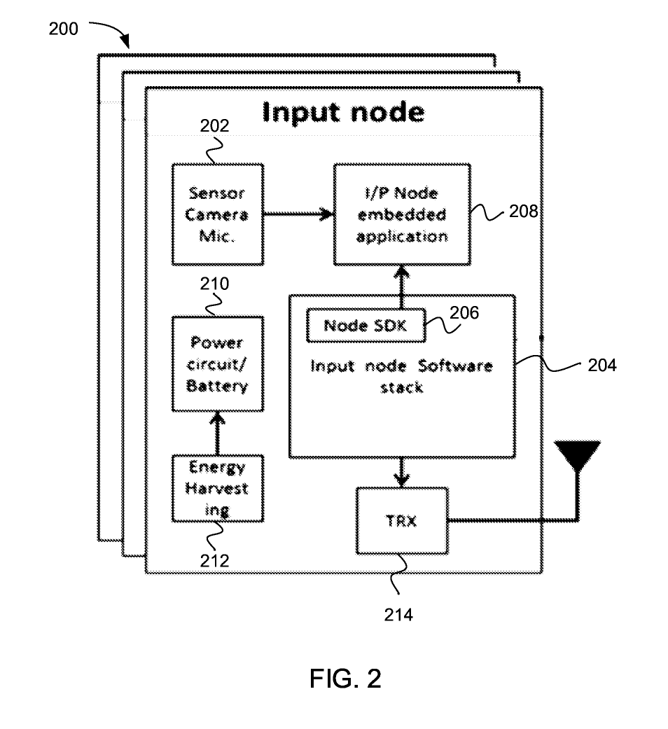

FIG. 2 is an exemplary block diagram of an input node 200. The input node 200 may include a wearable wireless input node. The input node 200 may be part of an enclosure that is worn on, for example, a user's wrist, arm, chest, leg, or other areas on the user's body. In one example, the user may wear a plurality of input nodes 200 on the user's body, wherein the plurality of input nodes 200 are in separate enclosures.

The input node 200 may include a data acquisition unit 202 to collect various types of input data, such as measurements, images, videos, sounds, temperatures, movements, light, etc. The data acquisition unit 202 may collect various types of body characteristics, such as heart rate, body temperature, respiration rate, blood pressure, etc. The data acquisition unit 202 may collect the various types of input data using an appropriate transducer, such as a camera, microphone, video camera, sensor, global positioning system (GPS), photo detector, gyroscope, and/or accelerometer. The data acquisition unit 202 may collect measurements using various types of sensors, which include but are not limited to, biometric sensors, sound sensors (e.g., microphones, hydrophones), movement sensors (e.g., speed sensors), chemical sensors, weather or environmental sensors (e.g., temperature sensors), navigational sensors (e.g., altimeters, gyroscopes), optical sensors, and proximity sensors. The data acquisition unit 202 may collect the various types of input data and provide the input data to an input node embedded application 208 operating at the input node 200.

The input node 200 may include a plurality of input (VP) node embedded applications 208. The embedded applications 208 may enable the input node 200 to collect and/or receive one or more types of input data. The embedded applications 208 may, for example, refine data collected at a sensor to be sent to a processing node. For example, an embedded application 208 for the input node 200 may be to compress sounds or reduce noises before sending the sounds to a processing node. In some examples, the embedded applications 208 may enable for the collection of heart rate information using a heart rate monitor, a current acceleration using an accelerometer, or a current temperature using a temperature sensor.

The wearable software stack 204 may include a set of defacto standard application programming interfaces (APIs). New embedded applications 208 may use the set of defacto standard APIs to develop new functionalities that take advantage of available hardware and software resources of the input node 200. In addition, the wearable software stack 204 may include at least one software development kit (SDK) or node SDK 206. The node SDK 206 may enable pre-processing at the input node 200, such as image feature extraction or sensor data conditioning.

The input node 200 may include a wearable software stack 204 or an input node software stack. The wearable software stack 204 may include a communication framework for establishing a secure logical data channel with a wearable processor software stack. In one example, the input node 200 may communicate the information collected at the data acquisition unit 202 to a processing node. The communication framework for establishing the secure logical channel may use, for example, 3GPP LTE (e.g., Releases 8, 9, 10 or 11), IEEE 802.16 standard (i.e., WiMAX), IEEE 802.11 standard (i.e., WiFi), IEEE 802.15 standard (i.e., family of personal area networks), Bluetooth, Bluetooth low energy, low power WiFi, or other wireless local area network standards.

The wearable software stack 204 may include an interface with a wireless transceiver 214. The wireless transceiver 214 may enable communications between the input node 200 and the processing node and/or an output node. In addition, the wireless transceiver 214 may enable communications between the input node 200 and a remote server, such as a cloud server.

The input node 200 may include a power circuit 210. In one example, the power circuit may include a rechargeable battery. The rechargeable battery may enable the user to wear the input node 200 for extended periods of time before recharging the battery in the input node 200. In an alternative configuration, the input node 200 may include an energy harvesting module 212. The energy harvesting module 212 may derive energy for the input node 200 from external sources, such as solar power, thermal power, wind energy, kinetic energy, etc. Since the input node 200 may likely use a relatively low amount of energy, the energy harvesting module 212 may provide a sufficient amount of energy to power the input node 200.

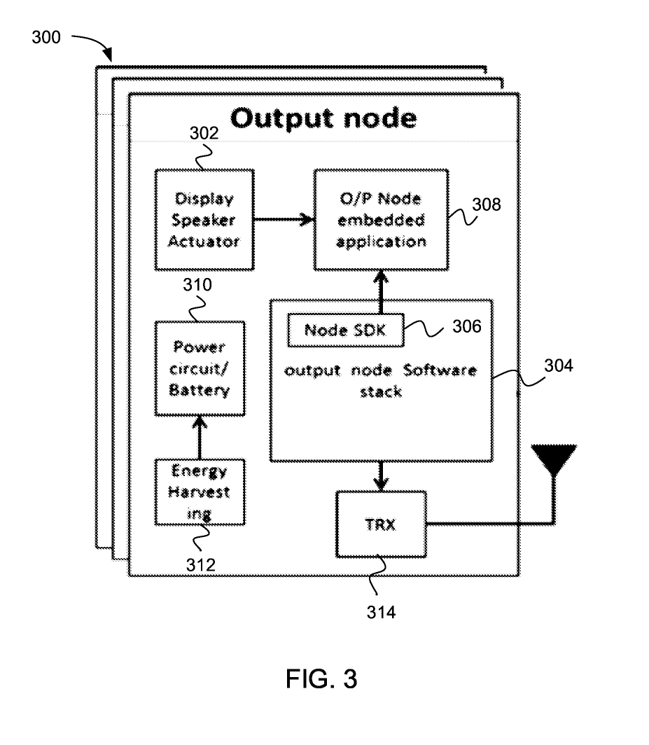

FIG. 3 is an exemplary block diagram of an output node 300. The output node 300 may include a wearable wireless output node. The output node 300 may be part of an enclosure that is worn on, for example, a user's wrist, arm, chest, leg, or other areas on the user's body. In one example, the user may wear a plurality of output nodes 300 on the user's body, wherein the plurality of output nodes 300 are in separate enclosures. The output node 300 may provide one or more types of physical output based on one or more wearable usage scenario applications executed at a processing node using the input data, or alternatively, based on a pre-scheduled task according to the wearable usage scenario application.

The output node 300 may include a data presentation unit 302 to present one or more types of physical output. The output node 300 may provide the physical output based on one or more applications that are executed at a processing node using input data. In addition, the output node 300 may provide the physical output according to a pre-scheduled task. The pre-scheduled task may be set as a one-time task by a user or may be a recurring task. For example, the output node 300 may be configured to display a user's blood glucose level every hour. The physical output may include, but is not limited to, mechanical output, acoustic output, or an optical output. For example, the data presentation unit 302 may present sensor data (e.g., temperature data), image data, video data, temperature data, etc. to a display screen or a projection device (e.g., a miniature overheard projector). As another example, the data presentation unit 302 may provide the user's heart rate or current velocity onto a display screen. The data presentation unit 302 may provide the acoustic output (e.g., sounds) to a loudspeaker. In one example, the data presentation unit 302 may provide the mechanical output via an actuator. The output data may be delivered from an output node embedded application 308, and the data presentation unit 302 may present the output data to an output device, such as the display screen, speaker, actuator, etc.

As another example, the data presentation unit 302 may send an alerting message to a network entity via a network connection based on an application that is executed using the input data. For example, an alert may be sent when a user wearing the output node 300 is unconscious. In other words, the input data may indicate a blood pressure and pulse rate of the user, and based on a rise in the blood pressure and/or a slowing of the pulse rate, the user may be detected as unconscious and the data presentation unit 302 may send the alert to the network entity.

The output node 300 may include a plurality of output (O/P) node embedded applications 308. The embedded applications 308 may enable the output node 300 to provide one or more types of physical output. The embedded applications 308 may, for example, refine or process data that is received from a processing node. For example, an embedded application 208 for the output node 200 may process data received from the processing node according to a nature of the display screen (e.g., the data may be processed differently when the data is displayed on wearable electronic glasses as opposed to a wearable electronic watch). In some examples, the embedded applications 308 may enable for the delivery of heart rate information, a current acceleration, or a current temperature to a display screen or speaker coupled to the output node 300.

The wearable software stack 304 may include a set of defacto standard application programming interfaces (APIs). New embedded applications 308 may use the set of defacto standard APIs to develop new programming functionalities or adding/modifying features of the wearable software stack 304 that take advantage of available hardware and software resources of the output node 300. In addition, the wearable software stack 304 may include at least one software development kit (SDK) or node SDK 306. The node SDK 306 may enable post-processing at the output node 300, such as repeating an action of an actuator if the user wearing the output node 300 is not responding or giving feedback to a processing node.

The output node 300 may include a wearable software stack 304 or an output node software stack. The wearable software stack 304 may include a communication framework for establishing a secure logical data channel with a wearable processor software stack. The communication framework for establishing the secure logical channel may use, for example, 3GPP LTE (e.g., Releases 8, 9, 10 or 11), IEEE 802.16 standard (i.e., WiMAX), IEEE 802.11 standard (i.e., WiFi), IEEE 802.15 standard (i.e., family of personal area networks), Bluetooth, Bluetooth low energy, low power WiFi, or other wireless local area network standards.

The wearable software stack 304 may include an interface with a wireless transceiver 314. The wireless transceiver 314 may enable communications between the output node 300 and the processing node and/or an input node. In addition, the wireless transceiver 314 may enable communications between the output node 300 and a remote server, such as a cloud server.

The output node 300 may include a power circuit 310. In one example, the power circuit may include a rechargeable battery. The rechargeable battery may enable the user to wear the output node 300 for extended periods of time before recharging the battery in the output node 300. In an alternative configuration, the output node 300 may include an energy harvesting module 312. The energy harvesting module 312 may derive energy for the output node 300 from external sources, such as solar power, thermal power, wind energy, kinetic energy, etc. Since the output node 300 may likely use a relatively low amount of energy, the energy harvesting module 312 may provide a sufficient amount of energy to power the output node 300.

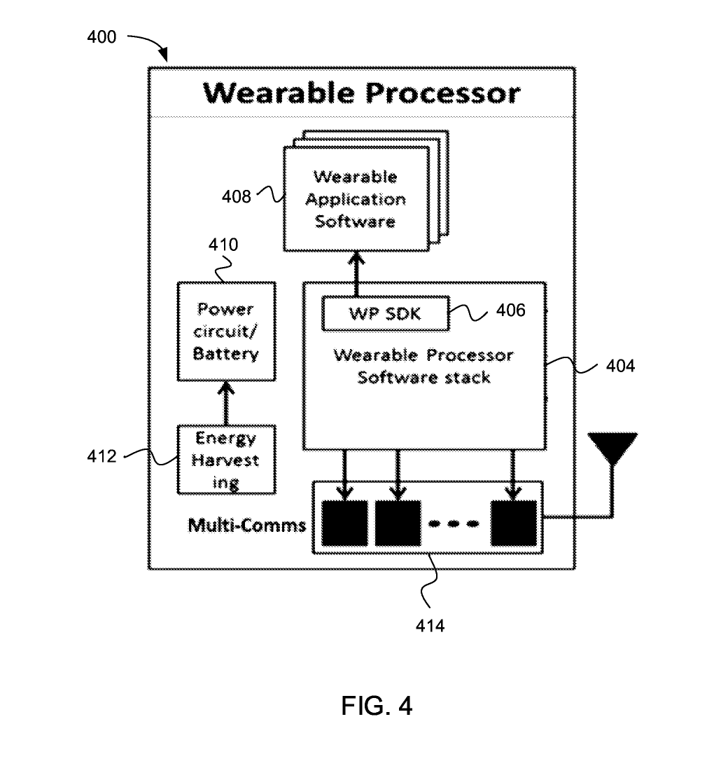

FIG. 4 is an exemplary block diagram of a wearable processor 400. The wearable processer 400 may be a wearable wireless processing node. The wearable processor 400 may be part of an enclosure that is worn on, for example, a user's wrist, arm, chest, leg, or other areas on the user's body. The wearable processor 400 may execute one or more wearable usage scenario applications using input data received at an input node. The execution of the wearable usage scenario applications may generate one or more types of output data that is communicated to an output node. The wearable processor 400 may be a standalone unit or a software stack integrated with a mobile computing device on the user.

The wearable processor 400 may include a wearable processor software stack 404. The wearable processor software stack 304 may include a communication framework for establishing a secure logical data channel with various wearable node software stacks, such as the wearable node software stacks included in the input node and the output node.

The communication framework may establish a secure logical data channel with a server (e.g., a cloud server), wherein the server is within a wireless infrastructure that is available to the wearable processor 400. The server may provide a specific service to the user based on the user's request. For example, the wearable processor 400 may provide the server with an image and an application on the server may perform image recognition on the image and communicate resulting information to the wearable processor 400. As another example, the wearable processor 400 may provide the server with a geographical location associated with the wearable processor 400 and the server may generate weather information according to the geographical location and send the weather information to the wearable processor 400. In addition, the server may collect data from the user and present the data to a specific data collection entity or data processing entity. For example, the server may collect usage information from the user and present the usage information to a usage collection entity.

The communication framework may establish a secure logical data channel with additional wearable wireless processing nodes or processing units that are located in proximity to the wearable processor 400. The wearable processor 400 may collaborate or perform unified processing with the additional wearable wireless processing nodes. For example, the additional wearable wireless processing nodes may include hardware or software capabilities, various types of sensors, high-resolution cameras, etc. that are not included in the wearable processor 400. The additional wearable wireless processing nodes may collect input data and/or execute a wearable usage scenario application using input data collected at the wearable processor 400 and/or the additional wearable wireless processing nodes. Therefore, the wearable processor 400 may utilize capabilities of the additional wearable wireless processing nodes in order to provide physical output to the user.

The communication framework for establishing the secure logical channel may use, for example, 3GPP LTE (e.g., Releases 8, 9, 10 or 11), IEEE 802.16 standard (i.e., WiMAX), IEEE 802.11 standard (i.e., WiFi), IEEE 802.15 standard (i.e., family of personal area networks), Bluetooth, Bluetooth low energy, low power WiFi, or other wireless local area network standards.

The wearable processor 400 may include wearable application software 408 or wearable usage scenario applications. The wearable application software 408 may be executed at the wearable processor 400 according to input data received at an input node. The wearable application software 408 may enable the wearable processor 400 to perform numerous functions, including but not limited to, pattern recognition, situation analysis, machine learning, decision making, searching, etc. In some examples, the wearable application software 408 may perform facial or object recognition or detect deficiency in an industrial operation. As another example, the wearable application software 408 may detect threatening words from a thief during an emergency and send an SOS message to authorities via an output node. In addition, the wearable application software 408 may provide communication functionality between the wearable processor 400 and mobile computing devices, input nodes, output nodes, and additional processing nodes located in proximity to the wearable processor 400.

The wearable processor software stack 404 may include a set of defacto standard application programming interfaces (APIs). Wearable application software 408 may use the set of defecto standard APIs to develop new programming functionalities or adding/modifying features of the wearable processor software stack 404 that take advantage of available hardware and software resources of the wearable processor 400. In addition, the wearable processor software stack 404 may include at least one wearable processor software development kit (WP SDK) 406. The WP SDK 406 may enable processing to occur at the wearable processor 400.

The wearable processor 400 may include an interface with a wireless transceiver 414. The wireless transceiver 414 may enable multiple wireless communication options for communications between the wearable processor 400 and the mobile computing devices, input nodes, output nodes, and additional processing nodes located in proximity to the wearable processor 400. In addition, the wearable processor 400 may include one or more interfaces with local and external databases. The local and external databases may contain personal information of the user wearing the wearable processor 400 and/or information related to the wearable application software 408 or wearable usage scenario applications. Furthermore, the wearable processor 400 may be configured to securely update the local and external databases using external information from a server, or alternatively, using heuristic information collected by an input node based on the user's experiences.

The local and external databases may be updated after the user wearing the wearable processor 400 acknowledges and/or accepts the heuristic information collected over the user experience. As an example, user behavior for certain situations may be added at a local database so that the wearable processor 400, using supervised learning, can act accordingly in new situations using the user's past behavior. In addition, external databases may be used in crowd sourcing solutions. For example, a user's wearable processor 400 may report traffic congestion information (e.g., average speed) for certain geographical areas to a server so that the server can estimate traffic conditions using data collected from a plurality of different users.

The wearable processor 400 may include a power circuit 410. In one example, the power circuit may include a rechargeable battery. The rechargeable battery may enable the user to wear the wearable processor 400 for extended periods of time before recharging the battery in the wearable processor 400. In an alternative configuration, the wearable processor 400 may include an energy harvesting module 412. The energy harvesting module 412 may derive energy for the wearable processor 400 from external sources, such as solar power, thermal power, wind energy, kinetic energy, etc. Since the wearable processor 400 may be likely to use a relatively low amount of energy, the energy harvesting module 412 may provide a sufficient amount of energy to power the wearable processor 400.

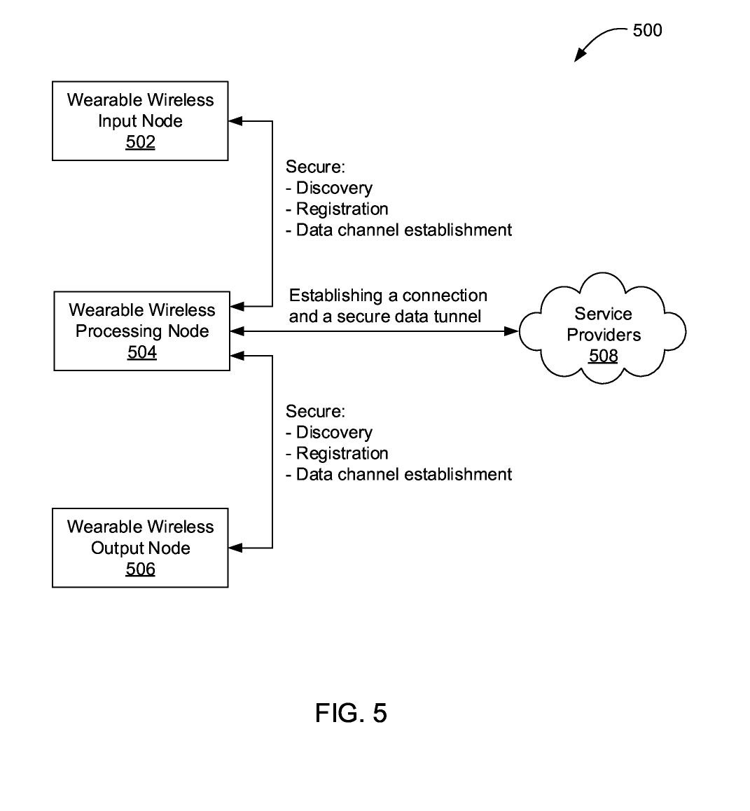

FIG. 5 is an exemplary block diagram 500 illustrating communications between a wearable wireless input node 502, a wearable wireless processing node 504, a wearable wireless output node 506 and one or more service providers 508. The wearable wireless processing node 504 may securely discover the wearable wireless input node 502 and the wearable wireless output node 506. The wearable wireless processing node 504 may securely register the wearable wireless input node 502 and the wearable wireless output node 506. In addition, the wearable wireless processing node 504 may securely establish a data channel to the wearable wireless input node 502 and the wearable wireless output node 506. In one configuration, the wearable wireless processing node 504 may perform discovery, registration and data channel establishment using an applicable communication standard, such as Bluetooth, Bluetooth low energy, WiFi, low power WiFi, or the IEEE 802.15 family of personal area networks.

The wearable wireless processing node 504 may establish a connection and secure data tunnel with the service providers 508. The service providers 508 may reside on an external server, such as a cloud server. The service providers 508 may execute usage applications using input data provided by the wearable wireless processing node 504. For example, the service providers 508 may provide various functionalities, such as pattern recognition, situation analysis, machine learning, searching, and decision making for the wearable wireless processing node 504.

In one configuration, the wearable wireless nodes (i.e., the wearable wireless input node 502, wearable wireless processing node 504, and wearable wireless output node 506) may be in various modes or states of operation. For example, the wearable wireless nodes may be in an on state, off state, or standby state. When the wearable wireless nodes are off, manual activation from the user may turn the wearable wireless nodes back on. When the wearable wireless nodes are on, the functionality and capability of the wearable wireless nodes may be fully operational. When the wearable wireless nodes are in the standby state or a low power state, the wearable wireless nodes may switch between the on state and the off state periodically based on a dynamic duty cycle mechanism. When in the standby state or sleep state, the wearable wireless node may wake itself up based on an internal trigger or listen to external wake up signals from the wearable wireless processing node 504. The wearable wireless node may have more than one sleep state based on usage, power management requirements and/or implementation complexity.

The wearable wireless processing node 504 may contain a communication framework that is resident in a software stack in the wearable wireless processing node 504. The communication framework may allow for wearable wireless node discovery, wearable wireless processor discovery, wearable wireless node registration, data channel establishment, secure data tunneling, and admission authorization and authentication. As previous discussed, the communication framework may include use of an applicable communication standard, such as Bluetooth, Bluetooth low energy, WiFi, low power WiFi, or the IEEE 802.15 family of personal area networks in order to perform the discovery, registration, data channel establishment, secure data tunneling, and admission authorization and authentication.

The wearable wireless processing node 504 may detect a presence of the wearable wireless input node 502 and the wearable wireless output node 506 during the wearable wireless node discovery. The wearable wireless processing node 504 may maintain a list of the wearable wireless nodes' current state (e.g., off state, on state or standby state). In addition, the wearable wireless processing node 504 may detect additional wearable wireless processing nodes that are located in proximity to the wearable wireless processing node 504 during wearable wireless processing node discovery.

The wearable wireless processing node 504 may register wearable wireless nodes (e.g., the wearable wireless input node 502 and the wearable wireless output node 506) and additional wearable wireless processing nodes after discovery of the wearable wireless nodes. The wearable wireless nodes may be registered at the wearable wireless processing node 504 and added to a wireless network. The wearable wireless nodes may be assigned a local unique address for future reference and communication with the wearable wireless processing node 504. In addition, the wearable wireless nodes may register a terminal type and capability information associated with the wearable wireless nodes.

The communication framework in the wearable wireless processing node 504 may provide functionality to set up a secure data connection and data tunnel between two or more entities (e.g., wearable wireless nodes) in different network topologies. The secure data tunneling may include encryption and decryption mechanisms between the wearable wireless nodes and the wearable wireless processing node 504, end-to-end secure data transfer mechanisms between the wearable wireless processing node 504 and a service provider on the cloud, and secure data transfer mechanisms between various wearable wireless processing nodes. In addition, the communication framework may contain a mechanism to authenticate the wearable wireless processing node 504 and the wearable wireless nodes. The authentication may be performed with cloud services and authorization of particular functions may be checked using the communication framework. In one configuration, the communication framework may keep track of various transactions (e.g., financial transactions) for an accurate accountability of activities performed with respect to the wearable wireless processing node 504.

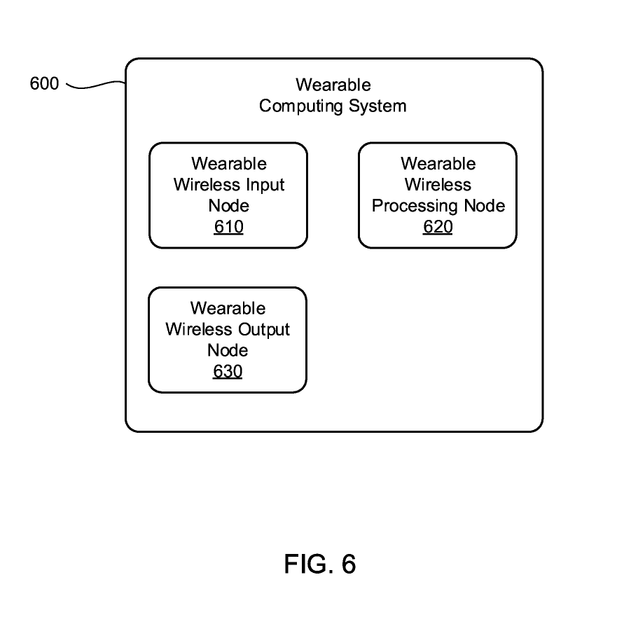

In another embodiment, a wearable computing system 600 is disclosed. FIG. 6 illustrates an example block diagram of the system 600. The system 600 comprises a wearable wireless input node 610 in a first enclosure to receive one or more types of input data. The system 600 includes a wearable wireless processing node 620 in a second enclosure to execute one or more wearable usage scenario applications using the input data received at the input node. The system 600 includes a wearable wireless output node 630 in a third enclosure to provide one or more types of physical output based on the one or more applications executed using the input data.

In one configuration, the wearable wireless processing node can be further configured to receive additional wearable usage scenario applications; and execute the additional wearable usage scenario applications using input data received at the input node. In one example, the wearable wireless output node provides the one or more types of physical output based on a pre-scheduled task. In addition, communications between the wearable wireless input node, the wearable wireless processing node and the wearable wireless output node are performed via one or more transceivers using Institute of Electrical and Electronics Engineers (IEEE) 802.15.6-2012, Bluetooth low energy, or low power Wi-Fi. Furthermore, the wearable wireless input node is further configured to receive the one or more types of input data from one or more of: a biometric sensor, a camera, a motion sensor, a scanner, or a microphone.

In one example, the one or more types of physical output include one or more of: a mechanical output, an acoustic output, or an optical output. In yet another example, the wearable wireless processing node can be further configured to generate an alert message using the input data based on the wearable usage scenario application executed at the wearable wireless processing node; and communicate the alert message to additional wearable wireless processing nodes. In addition, the mechanical output is provided by an actuator, the acoustic output is provided by a speaker and the optical output is provided by a display screen. Furthermore, each of the wearable wireless input node, the wearable wireless processing node and the wearable wireless output node are powered using a battery or via an energy harvesting module.

In one configuration, the wearable wireless input node, the wearable wireless processing node and the wearable wireless output node may each be in one of: an on state, an off state or a standby state. In addition, the wearable wireless processing node is further configured to discover the wearable wireless input node and the wearable wireless output node and authenticate the wearable wireless input node and the wearable wireless output node.

In one configuration, the wearable wireless processing node is further configured to identify additional wearable wireless processing nodes that are proximately located to the wearable wireless processing node and authenticate the additional wearable wireless processing nodes. In addition, the wearable wireless processing node is further configured to execute the one or more wearable usage scenario applications using unified processing with the additional wearable wireless processing nodes located in proximity to the wearable wireless processing node. Furthermore, the wearable wireless processing node is further configured to communicate information with a mobile computing device, additional wearable wireless processing nodes located in proximity to the wearable wireless processing node, or a cloud database in order to execute the one or more wearable usage scenario applications. In one example, the wearable wireless processing node is further configured to securely update the cloud database using heuristic information collected over a user experience at the wearable wireless processing node.

Another example provides functionality 700 of computer circuitry of a wearable computing system operable to implement one or more wearable usage scenario applications. The functionality may be implemented as a method or the functionality may be executed as instructions on a machine, where the instructions are included on at least one computer readable medium or one non-transitory machine readable storage medium. The computer circuitry can be configured to receive one or more types of input data at a wearable wireless input node, the wearable wireless input node including a first set of application programming interfaces (APIs) and software development kits (SDKs) to perform input data pre-processing, as in block 710. The computer circuitry can be configured to execute one or more wearable usage scenario applications, at a wearable wireless processing node, using the input data received at the wearable wireless input node, the wearable wireless processing node including a set of application programming interfaces (APIs) to implement the one or more wearable usage scenario applications, as in block 720. The computer circuitry can be further configured to provide one or more types of physical output, at a wearable wireless output node, based on the one or more wearable usage scenario applications executed using the input data, the wearable wireless output node including a third set of APIs to perform physical output post-processing, as in block 730.

In one configuration, the wearable wireless input node, the wearable wireless processing node and the wearable wireless output node may each include a transceiver to perform communications using one or more radio access technologies (RATs). In addition, the wearable wireless processing node is configured to perform one or more of pattern recognition, situation analysis, machine learning and decision making. In one example, the wearable wireless processing node is integrated with a mobile computing device associated with a user. Furthermore, the wearable wireless input node is in a first enclosure, the wearable wireless processing node is in a second enclosure, and the wearable wireless output node in a third enclosure

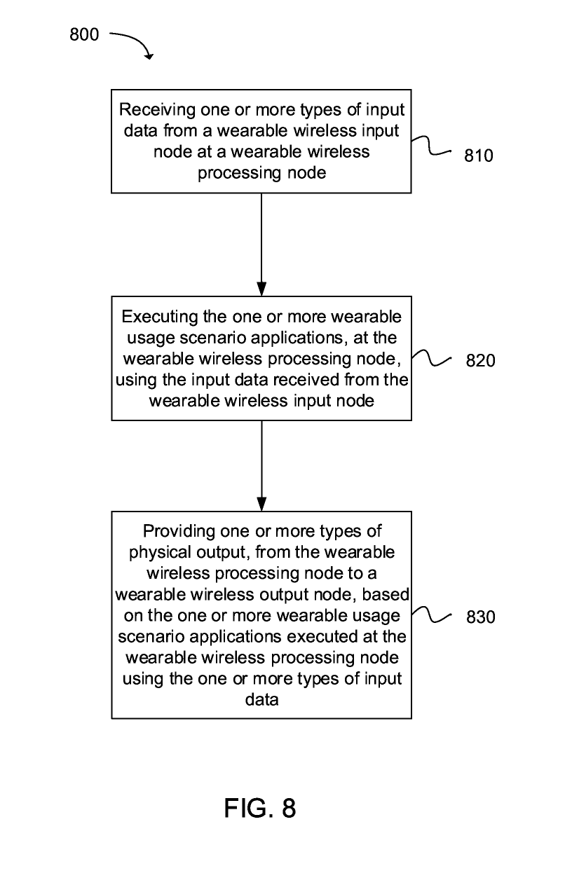

Another example provides a method 800 for implementing one or more wearable usage scenario applications, as shown in the flow chart in FIG. 8. The method may be executed as instructions on a machine, where the instructions are included on at least one computer readable medium or one non-transitory machine readable storage medium. The method includes the operation of receiving one or more types of input data from a wearable wireless input node at a wearable wireless processing node, as in 810. The method can include executing the one or more wearable usage scenario applications, at the wearable wireless processing node, using the input data received from the wearable wireless input node, as in block 820. The method can further include providing one or more types of physical output, from the wearable wireless processing node to a wearable wireless output node, based on the one or more wearable usage scenario applications executed at the wearable wireless processing node using the one or more types of input data, as in block 830.

In one configuration, the method can comprise communicating with the wearable wireless input node and the wearable wireless output node over a body area network (BAN). In addition, the method can comprise discovering the wearable wireless input node and the wearable wireless output node using a network discovery technique. In one example, the method can comprise discovering additional wearable wireless processing nodes that are located in proximity to the wearable wireless processing node using a network discovery technique. Furthermore, the method can comprise executing the one or more wearable usage scenario applications using unified processing with a mobile computing device, a cloud database, or the additional wearable wireless processing nodes that are located in proximity to the wearable wireless processing node.

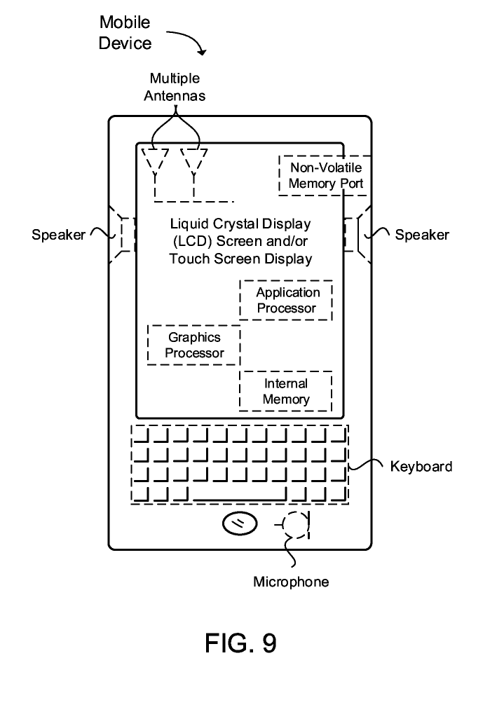

FIG. 9 provides an example illustration of the wireless device, such as a user equipment (UE), a mobile station (MS), a mobile wireless device, a mobile communication device, a tablet, a handset, or other type of wireless device. The wireless device can include one or more antennas configured to communicate with a node, macro node, low power node (LPN), or, transmission station, such as a base station (BS), an evolved Node B (eNB), a baseband unit (BBU), a remote radio head (RRH), a remote radio equipment (RRE), a relay station (RS), a radio equipment (RE), or other type of wireless wide area network (WWAN) access point. The wireless device can be configured to communicate using at least one wireless communication standard including 3GPP LTE, WiMAX, High Speed Packet Access (HSPA), Bluetooth, and WiFi. The wireless device can communicate using separate antennas for each wireless communication standard or shared antennas for multiple wireless communication standards. The wireless device can communicate in a wireless local area network (WLAN), a wireless personal area network (WPAN), and/or a WWAN.

FIG. 9 also provides an illustration of a microphone and one or more speakers that can be used for audio input and output from the wireless device. The display screen may be a liquid crystal display (LCD) screen, or other type of display screen such as an organic light emitting diode (OLED) display. The display screen can be configured as a touch screen. The touch screen may use capacitive, resistive, or another type of touch screen technology. An application processor and a graphics processor can be coupled to internal memory to provide processing and display capabilities. A non-volatile memory port can also be used to provide data input/output options to a user. The non-volatile memory port may also be used to expand the memory capabilities of the wireless device. A keyboard may be integrated with the wireless device or wirelessly connected to the wireless device to provide additional user input. A virtual keyboard may also be provided using the touch screen.

Various techniques, or certain aspects or portions thereof, may take the form of program code (i.e., instructions) embodied in tangible media, such as floppy diskettes, CD-ROMs, hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, EPROM, flash drive, optical drive, magnetic hard drive, solid state drive, or other medium for storing electronic data. The node and wireless device may also include a transceiver module, a counter module, a processing module, and/or a clock module or timer module. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

It should be understood that many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” means that a particular feature, structure, or characteristic described in connection with the example is included in at least one embodiment of the present invention. Thus, appearances of the phrases “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A wearable computing system, comprising:
a wearable wireless input node in a first enclosure to receive one or more types of input data;
a wearable wireless processing node in a second enclosure to execute one or more wearable usage scenario applications using the input data received at the input node; and
a wearable wireless output node in a third enclosure to provide one or more types of physical output based on the one or more applications executed using the input data.

2. The wearable computing system of claim 1, wherein the wearable wireless processing node is further configured to:
receive additional wearable usage scenario applications; and
execute the additional wearable usage scenario applications using input data received at the input node.

3. The wearable computing system of claim 1, wherein the wearable wireless output node provides the one or more types of physical output based on a pre-scheduled task.

4. The wearable computing system of claim 1, wherein communications between the wearable wireless input node, the wearable wireless processing node and the wearable wireless output node are performed via one or more transceivers using Institute of Electrical and Electronics Engineers (IEEE) 802.15.6-2012, Bluetooth low energy, or low power Wi-Fi.

5. The wearable computing system of claim 1, wherein the wearable wireless input node is further configured to receive the one or more types of input data from one or more of: a biometric sensor, a camera, a motion sensor, a scanner, or a microphone.

6. The wearable computing system of claim 1, wherein the one or more types of physical output include one or more of: a mechanical output, an acoustic output, or an optical output.

7. The wearable computing system of claim 1, wherein the wearable wireless processing node is further configured to:
generate an alert message using the input data based on the wearable usage scenario application executed at the wearable wireless processing node; and
communicate the alert message to additional wearable wireless processing nodes.

8. The wearable computing system of claim 5, wherein the mechanical output is provided by an actuator, the acoustic output is provided by a speaker and the optical output is provided by a display screen.

9. The wearable computing system of claim 1, wherein each of the wearable wireless input node, the wearable wireless processing node and the wearable wireless output node are powered using a battery or via an energy harvesting module.

10. The wearable computing system of claim 1, wherein each of the wearable wireless input node, the wearable wireless processing node and the wearable wireless output node are in at least one of: an on state, an off state or a standby state.

11. The wearable computing system of claim 1, wherein the wearable wireless processing node is further configured to discover the wearable wireless input node and the wearable wireless output node using a network discovery technique and authenticate the wearable wireless input node and the wearable wireless output node using a network authentication technique.

12. The wearable computing system of claim 1, wherein the wearable wireless processing node is further configured to discover additional wearable wireless processing nodes that are proximately located to the wearable wireless processing node and authenticate the additional wearable wireless processing nodes.

13. The wearable computing system of claim 10, wherein the wearable wireless processing node is further configured to execute the one or more wearable usage scenario applications using unified processing with the additional wearable wireless processing nodes located in proximity to the wearable wireless processing node.

14. The wearable computing system of claim 1, wherein the wearable wireless processing node is further configured to communicate information with a mobile computing device, additional wearable wireless processing nodes located in proximity to the wearable wireless processing node, or a cloud database in order to execute the one or more wearable usage scenario applications.

15. The wearable computing system of claim 12, wherein the wearable wireless processing node is further configured to securely update the cloud database using heuristic information collected over a user experience at the wearable wireless processing node.

16. A wearable computing system operable to implement one or more wearable usage scenario applications, the wearable computing system having computer circuitry configured to:
receive one or more types of input data at a wearable wireless input node, the wearable wireless input node including a first set of application programming interfaces (APIs) and software development kits (SDKs) to perform input data pre-processing;
execute one or more wearable usage scenario applications, at a wearable wireless processing node, using the input data received at the wearable wireless input node, the wearable wireless processing node including a second set of APIs to implement the one or more wearable usage scenario applications; and
provide one or more types of physical output, at a wearable wireless output node, based on the one or more wearable usage scenario applications executed using the input data, the wearable wireless output node including a third set of APIs to perform physical output post-processing.

17. The wearable computing system of claim 14, wherein each of the wearable wireless input node, the wearable wireless processing node and the wearable wireless output node include a transceiver to perform communications using one or more radio access technologies (RATs).

18. The wearable computing system of claim 14, wherein the wearable wireless processing node is configured to perform one or more of pattern recognition, situation analysis, machine learning and decision making.

19. The wearable computing system of claim 14, wherein the wearable wireless processing node is integrated with a mobile computing device associated with a user.

20. The wearable computing system of claim 14, wherein the wearable wireless input node is in a first enclosure, the wearable wireless processing node is in a second enclosure, and the wearable wireless output node in a third enclosure

21. A method for implementing one or more wearable usage scenario applications, the method comprising:
receiving one or more types of input data from a wearable wireless input node at a wearable wireless processing node;
executing the one or more wearable usage scenario applications, at the wearable wireless processing node, using the input data received from the wearable wireless input node; and
providing one or more types of physical output, from the wearable wireless processing node to a wearable wireless output node, based on the one or more wearable usage scenario applications executed at the wearable wireless processing node using the one or more types of input data.

22. The method of claim 19, further comprising communicating with the wearable wireless input node and the wearable wireless output node over a body area network (BAN).

23. The method of claim 19, further comprising discovering additional wearable wireless processing nodes that are located in proximity to the wearable wireless processing node using a network discovery technique.

24. The method of claim 23, further comprising executing the one or more wearable usage scenario applications using unified processing with a mobile computing device, a cloud database, or the additional wearable wireless processing nodes that are located in proximity to the wearable wireless processing node.
